(19) United States
(12) Patent Application Publication
(10) Pub. No.: US 2007/0026312 A1
(43) Pub. Date: Feb. 1, 2007

(54) Apparatus for and method of manufacturing electrodes, and battery using the electrode manufactured by the method

(75) Inventors: Naoki Imachi, Kobe-shi (JP); Hiroyuki Fujimoto, Kobe-shi (JP); Shin Fujitani, Kobe-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/491,877

(22) Filed: Jul. 25, 2006

(30) Foreign Application Priority Data
Jul. 29, 2005 (JP) 2005-221330

(51) Int. Cl. H01M 4/62; B05D 5/12; H01M 4/58; B05C 11/00

(52) U.S. Cl. 429/217; 427/58; 429/231.95; 429/221; 429/224; 429/223; 118/702

(57) ABSTRACT

A method of manufacturing an electrode having a current collector (1) and a plurality of active material layers (2, 3) formed on a surface of the current collector is provided. The method includes applying, one after another, a plurality of active material slurries in layers onto the surface of the current collector, each of the active material slurries containing a binder and a different active material from one another, to form the plurality of active material layers on the surface of the current collector, and thereafter, simultaneously drying all the active material slurries.

### BACKGROUND OF THE INVENTION

1. Field of the Invention

The present invention relates to non-aqueous electrolyte batteries such as lithium-ion batteries and polymer batteries, as well as apparatus for and methods of manufacturing electrodes used for such batteries.

2. Description of Related Art

Rapid advancements in size and weight reductions of mobile information terminal devices such as mobile telephones, notebook computers, and PDAs in recent years have created demands for higher capacity batteries as driving power sources for the devices. With their high energy density and high capacity, non-aqueous electrolyte batteries that perform charge and discharge by transferring lithium ions between the positive and negative electrodes have been widely used as the driving power sources for the mobile information terminal devices. Moreover, utilizing their characteristics, applications of non-aqueous electrolyte batteries, especially Li-ion batteries, have recently been broadened to middle-sized and large-sized batteries for power tools, electric automobiles, hybrid automobiles, etc., as well as mobile applications such as mobile telephones. As a consequence, demands for increased battery safety have been on the rise, along with demands for increased capacity and higher output power.

Many of commercially available non-aqueous electrolyte batteries, especially Li-ion batteries, adopt lithium cobalt oxide as their positive electrode active material. The energy that can be attained by lithium cobalt oxide, however, has almost reached the limit already; therefore, to achieve higher battery capacity, it has been inevitable to increase the filling density of the positive electrode active material. Nevertheless, increasing the filling density of the positive electrode active material causes battery safety to degrade when the battery is overcharged. In other words, since there is a trade-off between improvement in battery capacity and enhancement in battery safety, improvements in capacity of the battery have lately made little progress. Even if a new positive electrode active material that can serve as an alternative to lithium cobalt oxide will be developed in the future, the necessity of increasing the filling density of the positive electrode active material to achieve a further higher capacity will still remain the same because the energy that can be attained by that newly developed active material will also reach the limit sooner or later.

Conventional unit cells incorporate various safety mechanisms such as a separator shutdown function and additives to electrolyte solutions, but these mechanisms are designed assuming a condition in which the filling density of active material is not very high. For that reason, increasing the filling density of active material as described above brings about such problems as follows. Since the electrolyte solution's infiltrating performance into the interior of the electrodes is greatly reduced, reactions occur locally, causing lithium to deposit on the negative electrode surface. In addition, the convection of electrolyte solution is worsened and heat is entrapped within the electrodes, worsening heat dissipation. These prevent the above-mentioned safety mechanisms from fully exhibiting their functions, leading to further degradation in safety. Thus, it is necessary to establish a battery design that can make full use of those safety mechanisms without considerably compromising conventional battery designs.

To resolve the foregoing problems, various techniques have been proposed. For example, Japanese Published Unexamined Patent Application No. 2001-143705 proposes a Li-ion secondary battery that has improved safety using a positive electrode active material in which lithium cobalt oxide and lithium manganese oxide are mixed. Japanese Published Unexamined Patent Application No. 2001-143708 proposes a Li-ion secondary battery that improves storage performance and safety using a positive electrode active material in which two layers of lithium-nickel-cobalt composite oxides having different compositions are formed. Japanese Published Unexamined Patent Application No. 2001-338639 proposes a Li-ion secondary battery in which, for the purpose of enhancing battery safety determined by a nail penetration test, a plurality of layers are formed in the positive electrode and a material with high thermal stability is disposed in the lowermost layer of the positive electrode, to prevent the thermal runaway of the positive electrode due to heat that transfers via the current collector to the entire battery.

The above-described conventional batteries have the following problems.

(1) JP 2001-143705A

Merely mixing lithium cobalt oxide and lithium manganese oxide cannot fully exploit the advantage of lithium manganese oxide, which has excellent safety. Therefore, significant improvement in safety cannot be attained.

(2) JP 2001-143708A

In lithium-nickel-cobalt composite oxide, lithium ions that can be extracted from the crystals during overcharge are present abundantly in the crystals. Since the lithium can deposit on the negative electrode and become a source of heat generation, it is difficult to sufficiently improve the safety during overcharge, etc.

The above-described construction is intended for merely preventing the thermal runaway of a battery due to heat dissipation through the current collector under a certain voltage, and is not effective in preventing the thermal runaway of an active material that originates from deposited lithium on the negative electrode such as when overcharged.

To resolve the foregoing issues, the present inventors have proposed a positive electrode comprising positive electrode active material layers having a two-layer structure, wherein the positive electrode active material layer nearer the current collector contains as its main positive electrode active material an active material having a high resistance increase rate during overcharge, such as a spinel-type lithium manganese oxide and an olivine-type lithium phosphate compound, while the positive electrode active material layer nearer the electrode surface contains as its main positive electrode active material an active material having a large specific capacity, such as lithium cobalt oxide. This prevents the energy density from degrading and at the same time improves the tolerance of the battery to overcharging (Japanese Patent Application No. 2005-196435).

Nevertheless, the just-mentioned proposal leaves room for further improvement because of the following issue.

Specifically, in the battery having the just-described construction, the plurality of active material layers is formed on the current collector through the following process steps: applying a positive electrode active material slurry for the current collector-side layer (hereinafter also referred to as an “active material slurry for the first layer”); thereafter drying the active material slurry for the first layer; then applying a positive electrode layer slurry for the surface-side layer (hereinafter also referred to as an “active material slurry for the second layer”); and further drying the active material slurry for the second layer. According to the just-described method, however, when applying the active material slurry for the second layer, the active material slurry for the first layer has already undergone a drying process, whereby the positive electrode active material particles in the active material layer have been fixed by a binder agent. Therefore, when applying the active material slurry for the second layer coat, a component of the slurry, particularly the binder agent, tends to permeate or diffuse easily into the positive electrode active material layer nearer the current collector side (hereinafter also referred to as a “first active material layer”), the concentration of the binder becomes high in the first active material layer. This results in the problem of increase in the internal resistance of the electrode and consequent degradation in battery performance in normal charge-discharge operations.

To resolve this problem, it may appear possible to adopt a method of reducing the concentration of the binder in the active material slurry for the second layer, or a method of compressing the first active material layer after forming the first active material layer but before applying the active material slurry for the second layer. However, the former method has the drawback of insufficient cohesion within the positive electrode active material layer nearer the electrode surface (hereinafter also referred to as a “second active material layer”), whereas the latter method has the problems of electrode warpage caused by the compressing process and high manufacturing costs associated with the compressing process. For these reasons, it is difficult to employ the above-described techniques in reality.

In addition, since the amount of the binder permeating into the first active material layer from the active material slurry for the second layer does not vary greatly irrespective of whether the first active material layer is thin or not, the less the thickness of the first active material layer, the higher the concentration of the binder in the first active material layer will be, resulting in a very high internal resistance in the first active material layer. In particular, this tendency is noticeable with the materials that apt to result in a small coating density of the first active material layer.

Furthermore, intermittent coating, in which no active material slurry is applied other than the portions of the current collector surface where the coatings need to face each other, is adopted for non-aqueous electrolyte batteries such as represented by lithium-ion batteries, in order to reduce excessive use of active materials and to achieve higher capacity through improvements in energy density. When the active material slurries are applied in sequence according to the above-described method, an additional problem arises that misalignment can occur between the first active material layer and the second active material layer because it is difficult to apply the active material slurry for the second layer exactly on the position where the active material slurry for the first layer has been applied.

### BRIEF SUMMARY OF THE INVENTION

Accordingly, it is an object of the present invention to provide an electrode manufacturing method that can improve the tolerance of the battery to overcharging while preventing degradation of battery performance in normal charge-discharge operations, which is due to an increase in internal resistance of the electrode, and that can also prevent such issues as the misalignment between active material layers, the degradation in cohesion between active materials, and the increase in manufacturing costs. It is another object of the invention to provide an apparatus for manufacturing an electrode that is used for the manufacturing method. It is still another object of the invention to provide a battery having an electrode manufactured by the manufacturing method.

In order to accomplish the foregoing and other objects, the present invention provides a method of manufacturing an electrode having a current collector and a plurality of active material layers formed on a surface of the current collector, comprising: applying, one after another, a plurality of active material slurries in layers onto the surface of the current collector, each of the active material slurries containing a binder and a different active material from one another, to form the plurality of active material layers on the surface of the current collector; and thereafter, simultaneously drying all the active material slurries.

The use of the above-described method, involving applying a plurality of active material slurries in layers one after another in a wet state to a current collector surface and thereafter simultaneously drying all the active material slurries, achieves such advantageous effects as follows. For simplicity of description, the following explanation of the advantageous effects describes the cases in which the structure of the active material layers comprises two layers, but it should be noted that the same advantageous effects are of course attained even when the active material layers are comprised of three or more layers.

Specifically, when the active material slurry for the second layer is applied, the active material slurry for the first layer has not yet undergone the drying step (in other words, the active material slurry for the first layer remains in a slurry state, or specifically, it has not become an active material layer in which positive electrode active material particles are fixed by a binder agent). Therefore, when applying the active material slurry for the second layer, a component in the slurry, particularly the binder agent, does not permeate or diffuse into the active material slurry for the first layer easily, so the concentration of the binder in the active material slurry for the first layer is prevented from increasing. As a result, the internal resistance of the electrode is prevented from increasing, and accordingly, the battery performance is prevented from degrading in normal charge-discharge operations.

In addition, the concentration of the binder in the first active material layer is prevented from increasing even without employing such techniques as reducing the concentration of the binder in the active material slurry for the second layer or compressing the first active material layer after forming the first active material layer form but before applying the active material slurry for the second layer. Consequently, it is possible to prevent problems such as degradation in cohesion within the second active material layer, as well as the electrode warpage and an increase in manufacturing costs that are due to the compressing process.

It is preferable that the plurality of active material slurries is applied in layers onto the current collector surface in a wet state by multilayer simultaneous die coating.

As described previously, intermittent coating, in which no active material slurry is applied other than the portions of the current collector surface where the coatings need to face each other, is adopted in fabricating non-aqueous electrolyte batteries such as lithium-ion batteries in order to achieve reduction in excessive use of active materials and to increase the capacity by improving energy density. The use of multilayer simultaneous die coating in applying active material slurries as in the above-described method makes it easier to apply the active material slurry for the second layer to the locations where the active material slurry for the first layer has been applied, and therefore can prevent misalignment between the first active material layer and the second active material layer.

It is preferable that the true densities of the active materials contained in the active material slurries be controlled so that the true densities of the active materials in the active material layers are in descending order from the current collector.

When the true density of the active material used for the first active material layer is small, in other words, when the coating density of the active material used for the first active material layer is low, the binder component in the active material slurry for the second layer tends to permeate or diffuse into the first active material layer more easily. Accordingly, when the present invention is applied to the electrode having such a construction, the advantageous effects of the present invention are achieved more effectively.

It is preferable that the plurality of active material layers comprise two layers, and that the thickness of the active material layer that is in contact with the current collector be controlled to be equal to or less than ½ of the total thickness of the plurality of active material layers.

As already mentioned, the less the thickness of the first active material layer, the higher the concentration of the binder in the first active material layer will be, resulting in a very high internal resistance in the first active material layer. For this reason, the advantageous effects are exerted more effectively in such an electrode in which the thickness of the active material layer being in contact with the current collector is controlled to be equal to or less than ½ of the total thickness of the active material layers.

It is preferable that the electrode be a positive electrode.

Although the present invention is most suitably applied to a positive electrode, the invention may of course be applied to a multilayered negative electrode.

It is preferable that the layer being in contact with the current collector comprise as its main active material an olivine-type lithium phosphate compound represented by the general formula LiMPO4, where M is at least one element selected from the group consisting of Fe, Ni, and Mn.

When, as in the foregoing construction, the first active material layer (the active material layer being in contact with the current collector) contains as its main active material an olivine-type lithium phosphate compound, the current collection performance lowers in the second active material layer, which generally shows a high reactivity during overcharge, because the olivine-type lithium phosphate compound shows a high resistance increase rate during overcharge. Consequently, the active material of the second active material layer is not charged to the charge depth that should otherwise reach. Accordingly, the amount of the lithium deintercalated from the positive electrode in the overcharge region (especially the amount of the lithium deintercalated from the second active material layer) decreases, reducing the total amount of lithium deposited on the negative electrode. Consequently, the amount of heat produced due to the reaction between the electrolyte solution and the lithium deposited on the negative electrode correspondingly reduces, thereby preventing the deposition of dendrite. Moreover, the thermal stability of the positive electrode active material (especially of the active material in the second layer that becomes instable because of the extraction of lithium from the crystals) is also kept relatively high because the charge depth does not become deep; therefore, the reaction between the positive electrode active material and the excessive electrolyte solution existing in the separator etc. can be inhibited.

Although possible examples of the active material having the highest resistance increase rate during overcharge may include the spinel-type lithium manganese oxide, the olivine-type lithium phosphate compound shows a greater increase in the direct current resistance than the spinel-type lithium manganese oxide at the time when lithium ions are extracted from the interior of the crystals. Moreover, since the olivine-type lithium phosphate compound exhibits a lower potential than the spinel-type lithium manganese oxide at the time when almost all the lithium ions have been extracted from the interior of the crystals, the above-described advantageous effects emerge before the charge depth reaches to a depth at which the lithium cobalt oxide etc. that is nearer the surface of the positive electrode starts to degrade in terms of safety. Thus, the improvement effect of tolerance of the battery to overcharging is exhibited more effectively.

Furthermore, the olivine-type lithium phosphate compound shows a less true density of the active material than the spinel-type lithium manganese oxide, and therefore, the advantageous effects achieved by the present invention become more effective.

It should be noted that, in the present specification, the term the “main active material” of an active material layer herein means an active material that accounts for 50 mass % or greater with respect to the total mass of all the active materials in the active material layer.

It is preferable that the layer nearer the electrode outer surface comprises lithium cobalt oxide as its main active material.

Lithium cobalt oxide has a large capacity per unit volume. Therefore, when lithium cobalt oxide is contained as a positive electrode active material as in the foregoing construction, the capacity of the battery can be increased.

It is preferable that the total mass of the lithium cobalt oxide is controlled to be greater than the total mass of the olivine-type lithium phosphate compound.

When, as in the foregoing construction, the active material layer contains lithium cobalt oxide as a positive electrode active material and the total mass of the lithium cobalt oxide is controlled to be greater than that of the spinel-type lithium manganese oxide, the energy density of the battery as a whole can be increased because the lithium cobalt oxide has a greater specific capacity than the spinel-type lithium manganese oxide.

The present invention also provides a battery comprising a positive electrode, a negative electrode, and a separator interposed between the electrodes, wherein at least one of the electrode comprises a current collector and a plurality of active material layers formed on a surface of the current collector and is formed by the steps of: applying, one after another, a plurality of active material slurries in a wet state in layers, each of the plurality of active material slurries containing a binder and a different active material from one another; and thereafter simultaneously drying all the active material slurries.

It is preferable that the at least one of the electrodes be a positive electrode, and that among the plurality of active material layers, the layer in contact with the current collector contain an olivine-type lithium phosphate compound represented by the general formula LiMPO₄, where M is at least one element selected from the group consisting of Fe, Ni, and Mn.

It is preferable that the plurality of active material layers comprise two layers, that among the two layers of the active material layers, the layer nearer a surface of the electrode contain lithium cobalt oxide, and that the total mass of the lithium cobalt oxide be greater than the total mass of the olivine-type lithium phosphate compound.

In order to accomplish the foregoing and other objects, the present invention also provides an apparatus for apparatus for manufacturing electrodes, comprising: conveying means for conveying a current collector; a plurality of active material applying ports provided near a conveyance passage of the current collector conveyed by the conveying means, for applying different active material slurries one after another in layers onto the current collector; discharge-timing-adjusting means for adjusting timing with which the active material slurries are discharged from the plurality of active material applying ports; drying means disposed downstream from the plurality of active material applying ports in the conveyance passage of the current collector, for drying the active material slurries having been layered; and controlling means for controlling the conveying means and the discharge-timing-adjusting means.

With the use of the foregoing manufacturing apparatus, the active material slurries different from one another are applied one after another onto the current collector so as to form layers, from the plurality of active material applying ports provided in proximity to the conveyance passage of the current collector, which is conveyed by the conveying means, and thereafter, the layered active material slurries are dried by the drying means disposed downstream from the active material applying ports. This means that the different active material slurries are applied onto the current collector in a wet state and thereafter dried, so the foregoing apparatus is most favorable for the above-described methods of manufacturing electrodes.

Moreover, since the discharge-timing-adjusting means is capable of adjusting the discharge timing for the respective active material slurries that are discharged from the plurality of active material applying ports means, it becomes possible to apply the active material slurry for the second layer exactly to the location where the active material slurry for the first layer has been applied. Therefore, degradation in energy density can be prevented.

The present invention achieves the advantageous effect of improving tolerance of a battery to overcharging while preventing degradation in battery performance during normal charge-discharge operations, which is due to an increase in the internal resistance of the electrode. Moreover, the present invention serves to prevent problems such as misalignment between the active material layers, degradation in cohesion between active materials, and an increase of manufacturing costs.

### BRIEF DESCRIPTION OF THE DRAWINGS

FIG. 1 is a schematic illustrative drawing illustrating a multilayer simultaneous die coating apparatus;

FIG. 2 is a block diagram of the multilayer simultaneous die coating apparatus;

FIG. 3 is a timing chart illustrating the operation of the multilayer simultaneous die coating apparatus when used for coating a positive electrode active material slurry;

FIGS. 4A to 4C illustrate how a binder is diffused when the thickness of the first positive electrode active material layer is small; and

FIG. 5 illustrates how the binder is diffused when the thickness of the first positive electrode active material layer is large.

### DETAILED DESCRIPTION OF THE INVENTION

Hereinbelow, the present invention is described in further detail based on preferred embodiments thereof. It should be construed, however, that the present invention is not limited to the following preferred embodiments but various changes and modifications are possible without departing from the scope of the invention.

### Embodiment

Preparation of Positive Electrode

First, an olivine-type lithium iron phosphate (represented as LiFePO₄ and hereafter also referred to as “LFP”) serving as a positive electrode active material was mixed with a carbon conductive agent SP300 (made by Nippon Graphite Industries, Ltd.) and acetylene black also serving as a carbon conductive agent at a mass ratio of 92:3:2 to prepare a positive electrode mixture powder. It should be noted that the olivine-type lithium phosphate compound shows poor conductivity and is poor in load characteristics. For that reason, the secondary particles of the olivine-type lithium phosphate compound was allowed to contain 5% of carbon component at the baking stage of the positive electrode active material, in order to provide conductive paths in the secondary particles by the carbon so that sufficient battery performance can be ensured.

Next, 200 g of the resultant powder was charged into a mixer (for example, a mechanofusion system AM-15F made by Hosokawa Micron Corp.), and the mixer was operated at a rate of 1500 rpm for 10 minutes to cause compression, shock, and shear actions while mixing, to thus prepare a positive electrode active material mixture.

Subsequently, the resultant positive electrode active material mixture and a fluoropolymer-based binder agent (PVDF) were mixed at a mass ratio of 97:3 in N-methyl-2-pyrrolidone (NMP) solvent to prepare a positive electrode active material slurry for a first layer. Thereafter, the positive electrode active material slurry for the first layer was applied onto both sides of a positive electrode current collector made of an aluminum foil using doctor blading. In the application of the active material slurry using doctor blading, the gap was set at 100 μm with respect to the positive electrode current collector.

Thereafter, a positive electrode active material slurry for the second layer was prepared in the same manner as in the foregoing, except that lithium cobalt oxide (hereinafter also abbreviated as “LCO”) was used as the positive electrode active material. The resultant positive electrode active material slurry was applied on top of the positive electrode active material slurry for the first layer in a wet state. In the application of the active material slurry using doctor blading, the gap was set at 300 μm with respect to the positive electrode current collector.

Then, both of the positive electrode active material slurries were dried simultaneously and pressure-rolled. Thus, a positive electrode having a two-layer structure was prepared.

Preparation of Negative Electrode

A carbon material (graphite), CMC (carboxymethylcellulose sodium), and SBR (styrene-butadiene rubber) were mixed in an aqueous solution at a mass ratio of 98:1:1 to prepare a negative electrode slurry. Thereafter, the negative electrode slurry was applied onto both sides of a copper foil serving as a negative electrode current collector, and the resultant material was then dried and rolled. Thus, a negative electrode was prepared. The amount of the negative electrode active material applied was 172 g/10 cm², and the amount of the positive electrode active material applied was adjusted so that the negative electrode/positive electrode capacity ratio was 1.10 when the battery was initially charged at 4.2 V.

Preparation of Non-Aqueous Electrolyte Solution

A lithium salt composed mainly of LiPF₆ was dissolved at a concentration of 1.0 mole/L in a mixed solvent of 3:7 volume ratio of ethylene carbonate (EC) and diethyl carbonate (DEC) to prepare a non-aqueous electrolyte solution.

Preparation of Separator

A microporous polyethylene film was used as a separator.

Construction of Battery

Lead terminals were attached to the positive and negative electrodes, and the positive and negative electrodes were wound in a spiral form with the separator interposed therebetween. The wound electrodes were then pressed into a flat shape to obtain a power-generating element, and thereafter, the power-generating element was accommodated into an enclosing space made by an aluminum laminate film serving as a battery case. Then, the non-aqueous electrolyte solution was filled into the space, and thereafter the battery case was sealed by welding the aluminum laminate film, to thus prepare a battery.

Multilayer Simultaneous Die Coating

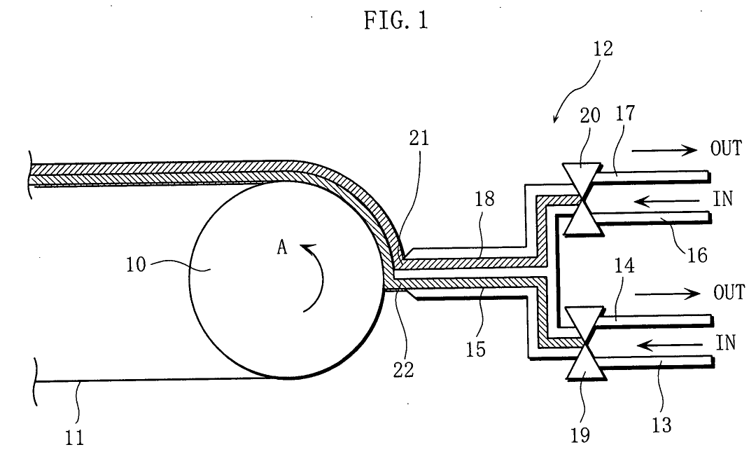

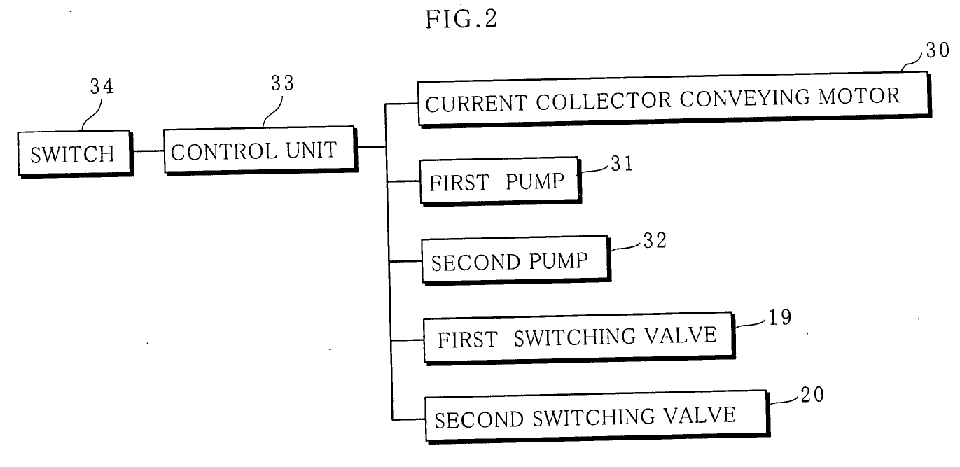

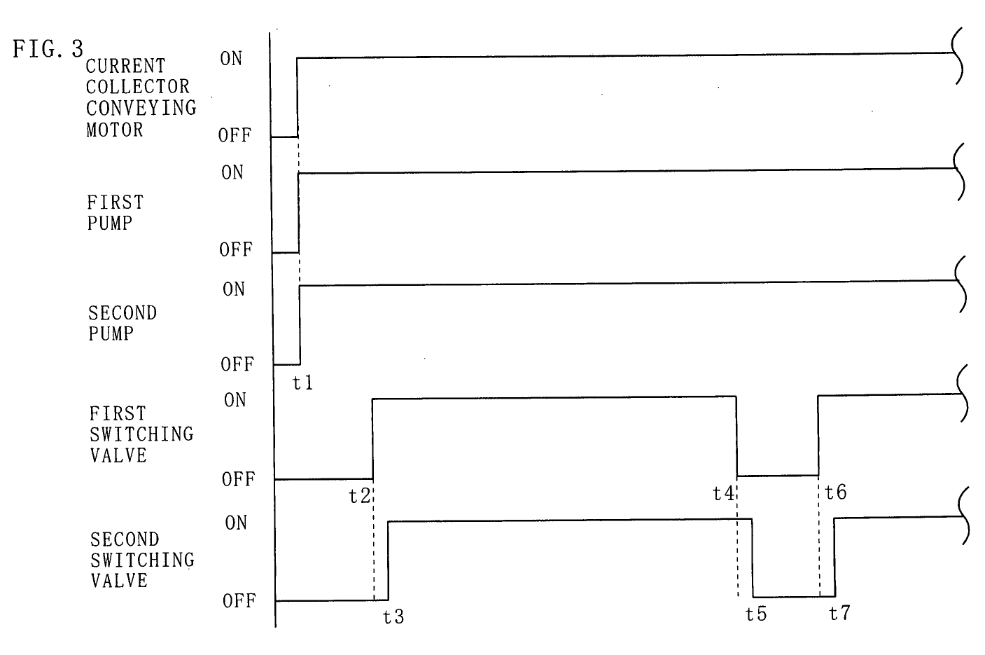

It is believed that multilayer simultaneous die coating, which is generally used for fabricating color films by photographic film manufacturers, is suitable for the method for applying the positive electrode active material slurry for the second layer onto the positive electrode active material slurry for the first layer in a wet state. The multilayer simultaneous die coating is better in productivity than the doctor blading mentioned above and is easily adapted to the intermittent coating. For this reason, multilayer simultaneous die coating is explained below with reference to FIGS. 1 to 3. FIG. 1 is a schematic illustrative drawing of a multilayer simultaneous die coating apparatus, FIG. 2 is a block diagram of the multilayer simultaneous die coating apparatus, and FIG. 3 is a timing chart illustrating the operation of the multilayer simultaneous die coating apparatus when used for coating a positive electrode active material slurry.

As illustrated in FIGS. 1 and 2, a multilayer simultaneous die coating apparatus 12 has a conveying roller 10 driven by a current collector conveying motor 30. The conveying roller 10 rotates in the direction indicated by the arrow A in FIG. 1 (anticlockwise), whereby a positive electrode current collector 11 is conveyed. A drying oven (not shown) for drying positive electrode active material slurries is disposed at a downstream location in the conveyance passage of the positive electrode current collector 11. A first application port 22, provided at the fore-end of a first coating passage 15, and a second application port 21, provided at the fore-end of a second coating passage 18, are disposed near the conveyance passage of the positive electrode current collector 11.

The first coating passage 15 is connected to a first transfer passage 13 via a first switching valve 19. The first transfer passage 13 is connected to a first reserve tank (not shown) in which the positive electrode active material slurry for the first layer is stored, and a first pump 31 is provided in the first transfer passage 13, for transferring the positive electrode active material slurry for the first layer. Reference numeral 14 denotes a first collection passage, connected to the first switching valve 19, for transferring the positive electrode active material slurry for the first layer to the first reserve tank when the positive electrode active material slurry for the first layer is not sent to the first coating passage 15.

On the other hand, the second coating passage 18 is connected to a second transfer passage 16 via a second switching valve 20. The second transfer passage 16 is connected to a second reserve tank (not shown) in which the positive electrode active material slurry for the second layer is stored, and a second pump 32 is provided in the second transfer passage 16, for transferring the positive electrode active material slurry for the second layer. Reference numeral 17 denotes a second collection passage, connected to the second switching valve 20, for transferring the positive electrode active material slurry for the second layer to the second reserve tank when the positive electrode active material slurry for the second layer is not sent to the second coating passage 18.

Referring to FIG. 2, a switch 34 is for operating the multilayer simultaneous die coating apparatus 12, and a control unit 33 is for outputting various operation signals to the current collector conveying motor 30, the first pump 31, the second pump 32, the first switching valve 19, and the second switching valve 20, in response to a signal from the switch 34.

With reference to FIG. 3, the operations of the multilayer simultaneous die coating apparatus 12 will be described below.

First, when the switch 34 is turned on, an “ON” signal is output from the switch 34 to the control unit 33. Then, the control unit 33 outputs an operation-starting signal to the current collector conveying motor 30 (time t1), and the positive electrode current collector 11 starts to be transferred by the conveying roller 10 rotating in the direction A (anticlockwise). The control unit 33 also outputs an operation-starting signal to the first pump 31 and the second pump 32 (time t1), so that the positive electrode active material slurry for the first layer and the positive electrode active material slurry for the second layer are respectively transferred from the first reserve tank and the second reserve tank through the first transfer passage 13 and the second transfer passage 16. In this case, however, because the first switching valve 19 and the second switching valve 20 are OFF, the positive electrode active material slurry for the first layer and the positive electrode active material slurry for the second layer are respectively collected into the first reserve tank and the second reserve tank through the first collection passage 14 and the second collection passage 17.

Next, when the positive electrode current collector 11 reaches a predetermined location, the control unit 33 first outputs an “ON” signal to the first switching valve 19 (time t2). Consequently, the positive electrode active material slurry for the first layer is transferred to the first coating passage 15, so the positive electrode active material slurry for the first layer discharged from the first applying port 22 is applied onto a surface of the positive electrode current collector. After a short interval, the control unit 33 outputs an “ON” signal to the second switching valve 20 (time t3). Consequently, the positive electrode active material slurry for the second layer is transferred to second coating passage 18, so the positive electrode active material slurry for the second layer discharged from the second applying port 21 is applied onto the surface of the positive electrode active material slurry for the first layer. It should be noted that the control unit 33 outputs an “ON” signal to the second switching valve 20 at a short interval after it outputs an “ON” signal to the first switching valve 19 because the foremost end of the positive electrode active material slurry for the first layer that has been applied to the positive electrode current collector takes a certain time to be conveyed to the location corresponding to the second applying port 21. Such controlling makes it possible to accurately apply the positive electrode active material slurry for the second layer onto the positive electrode active material slurry for the first layer.

Subsequently, after a predetermined time, the control unit 33 outputs an “OFF” signal to the first switching valve 19 (time t4), so the positive electrode active material slurry for the first layer is collected into first reserve tank through the first collection passage 14 and the application of the positive electrode active material slurry for the first layer onto the positive electrode current collector surface is halted. After a short interval, the control unit 33 outputs an “OFF” signal to the second switching valve 20 (time t5), so the positive electrode active material slurry for the second layer is collected into the second reserve tank through the second collection passage 17 and the application of the positive electrode active material slurry for the second layer onto the positive electrode active material slurry for the first layer is halted. The control unit 33 outputs an “OFF” signal to the second switching valve 20 at a short interval after it outputs an “OFF” signal to the first switching valve 19 for the same reason as discussed above.

Thereafter, in order to support the intermittent coating, the control unit 33 outputs an “ON” signal to the first switching valve 19 after a predetermined time (time t6) and, further after a short interval, the control unit 33 also outputs an “ON” signal to the second switching valve 20 (time t7), whereby the application is restarted.

It should be noted that the present invention does not necessarily require the die coating described above as long as the active material layers can be layered in a wet state. For example, it is believed possible to form the layers by employing, in combination, spray coating for applying the positive electrode active material slurry for the first layer and die coating for applying the positive electrode active material slurry for the second layer.

### EXAMPLES

### Preliminary Experiment 1

Reference Example Q1

A battery was fabricated in the same manner as in the Embodiment described above, except that the positive electrode active material slurry for the first layer was applied onto both sides of a positive electrode current collector made of an aluminum foil using doctor blading and thereafter the slurry was dried.

The battery fabricated in this manner is hereinafter referred to as Reference Battery Q1.

Reference Example Q2

A battery was fabricated in the same manner as in Reference Example Q1 above, except that the positive electrode active material layer was made of a single layer structure (a mixture of LCO and LFP was used for the positive electrode active material), instead of the two-layer structure.

The battery fabricated in this manner is hereinafter referred to as Reference Battery Q2.

Experiment

Reference Batteries Q1 and Q2 were studied for the tolerance of the battery to overcharging. The results are shown in Table 1 below. The conditions of the experiment were as follows. Samples of the batteries were subjected to a charge test using circuits that charge the batteries at currents of 1.0 It, 2.0 It, and 3.0 It, with a current of 750 mA being defined as 1.0 It, until the battery voltages reached 12 V and then they were charged at a constant voltage (with no lower current limit). After a voltage of 12 V was reached, the charging was continued for 3 hours.

Usually, a battery (battery pack) is provided with a protection circuit or a protective device such as a PTC device so that the safety of the battery in abnormal conditions can be ensured. In a unit cell as well, various safety mechanisms are adopted such as a separator shutdown (SD) function (the function to insulate the positive and negative electrodes from each other by heat-clogging pores in a microporous film) and additives to the electrolyte solution so that the safety can be ensured even without the protection circuit and the like. In the present experiment, however, such materials and mechanisms for improving the safety were eliminated except for the separator shutdown function in order to prove the superiority in safety of the batteries of the invention, and the behaviors of the batteries during overcharge were studied.

TABLE 1

| | | Positive electrode active material | | | Number of short-circuited batteries | | | |
|---|---|---|---|---|---|---|---|---|
| | | | First positive | | Charge depth at SD activation (%), | | | |
| | | Second positive | electrode active | | Highest battery surface | | | |
| | Positive | electrode active | material layer | | temperature (° C.) | | | |
| | electrode | material layer | (Current collector | | 1.0 It | 2.0 It | 3.0 It | 4.0 It |
| Battery | structure | (Surface side) | side) | Separator | overcharge | overcharge | overcharge | overcharge |
| Reference | Two layers | LCO | LFP | Ordinary separator | No | No | No | 2/2 |
| Battery Q1 | | | | | 151%, 87° C. | 151%, 85° C. | 149%, 93° C. | 157% |

| | | | | | | | |
|---|---|---|---|---|---|---|---|
| Reference | Two layers | LCO/LFP mixture | Ordinary separator | No | 2/2 | 2/2 | — |
| Battery Q2 | | | | 160%, 121° C. | 158% | 149% | |

The mass ratio of LCO (LiCoO₂) and LFP (LiFePO₄) in the positive electrode active material was 75:25 for all the batteries.
Both batteries had a design capacity of 780 mA, and the charge depth at SD activation was obtained by calculating charge capacity ratios up to SD activation with respect to the design capacity 780 mA.
Not all the batteries were studied for the highest battery surface temperature.

Table 1 clearly demonstrates that the samples of Reference Battery Q1 caused no short circuits up to the overcharging at 4.0 It, while the samples of Reference Battery Q2 caused short circuits when overcharged at 2.0 It.

It is believed that Reference Battery Q1 showed an improvement in the tolerance of a battery to overcharging over Reference Battery Q2 due to the following reasons.

Reference Battery Q1 adopts the LFP active material for the first positive electrode active material layer (the layer directly in contact with the positive electrode current collector). The LFP active material deintercalates most of the lithium ions from the interior of the crystals during the charge to 4.2 V, so almost no lithium ions can be extracted from the interior of the crystals even when overcharged beyond 4.2 V. Therefore, the resistance increase during overcharge becomes significantly large. When the resistance increase during overcharge of the first positive electrode active material layer is very large in this way, the current collection performance in the second positive electrode active material layer, which is made of the LCO active material, degrades. Consequently, the LCO active material in the second positive electrode active material layer is inhibited from being charged to the charge depth that would be reached otherwise. Accordingly, the amount of the lithium deintercalated from the positive electrode in the overcharge region (especially the amount of lithium deintercalated from LCO) reduces, and the total amount of the lithium deposited on the negative electrode correspondingly reduces. Consequently, the amount of heat produced due to the reaction between the electrolyte solution and the lithium deposited on the negative electrode reduces. Moreover, since thermal stability of the positive electrode active materials (particularly thermal stability of LCO that becomes instable because of the extraction of lithium from the crystals) is also kept relatively high because the charge depth does not become deeper.

More details are as follows. LCO deintercalates only about 60% of the lithium ions from the interior of the crystals when charged to 4.2 V, and the remaining about 40% of the lithium ions can be extracted from the interior of the crystals during overcharge. Therefore, the remaining portion of the lithium ions is not inserted into the negative electrode but is deposited on the negative electrode surface. In particular, when high-rate charging is conducted, the lithium-ion accepting capability reduces in the negative electrode, so the deposited lithium increases further. Moreover, since tetravalent cobalt cannot exist stably, CoO₂ is unable to exist in a stable state, and it releases oxygen from the interior of the crystals during overcharge and changes into a more stable crystal form. At this stage, if an electrolyte solution exists, it tends to cause a violent exothermic reaction, which becomes a cause of thermal runaway. Furthermore, the oxygen released from the positive electrode helps the inflammable gas produced by the decomposition of the electrolyte solution to catch fire more easily.

In view of this, if the LFP active material, which results in a significant resistance increase during overcharge, is used for the first positive electrode active material layer, as in Reference Battery Q1, the current collection performance of the second positive electrode active material layer made of the LCO active material is lowered and the LCO active material is inhibited from being charged easily, and thereby the amount of the lithium deintercalated from LCO decreases in the overcharge region. As a result, the total amount of the lithium deposited on the negative electrode decreases, and the amount of heat produced due to the reaction between the electrolyte solution and the lithium deposited on the negative electrode accordingly decreases. Moreover, thermal stability of LCO is also kept relatively high since the charge depth does not become deeper, leading to a decrease in the amount of oxygen generated. Thus, the safety of the battery during overcharge improves due to the mechanism discussed above.

### Preliminary Experiment 2

Reference Example R1

A battery was fabricated in the same manner as in the Embodiment described above, except that a single layer structure was adopted for the positive electrode active material layer (LCO alone was used as the positive electrode active material), instead of the two-layer structure.

The battery fabricated in this manner is hereinafter referred to as Reference Battery R1.

Reference Example R2

A battery was fabricated in the same manner as in Reference Example R1 above, except that LFP was used in place of LCO.

The battery fabricated in this manner is hereinafter referred to as Reference Battery R2.

Reference Example R3

A battery was fabricated in the same manner as in Reference Example R1 above, except that lithium manganese oxide (hereinafter also referred to as “LMO”) was used in place of LCO.

The battery fabricated in this manner is hereinafter referred to as Reference Battery R3.

Reference Example R4

A battery was fabricated in the same manner as in the Embodiment described above, except that the positive electrode active material slurry for the first layer was applied onto both sides of a positive electrode current collector made of an aluminum foil using doctor blading and thereafter the slurry was dried, and that the mass ratio of LCO and LFP in the positive electrode active material was 71:29.

The battery fabricated in this manner is hereinafter referred to as Reference Battery R4.

Reference Example R5

A battery was fabricated in the same manner as in Reference Example R4 above, except that the positive electrode active material layer was made of a single layer structure (a mixture of LCO and LFP was used for the positive electrode active material), instead of the two-layer structure.

The battery fabricated in this manner is hereinafter referred to as Reference Battery R5.

Reference Example R6

A battery was fabricated in the same manner as in Reference Example R4 above, except that the mass ratio of LCO and LFP in the positive electrode active material was 96:4.

The battery fabricated in this manner is hereinafter referred to as Reference Battery R6.

Reference Example R7

A battery was fabricated in the same manner as in Reference Example R5 above, except that the mass ratio of LCO and LFP in the positive electrode active material was 96:4.

The battery fabricated in this manner is hereinafter referred to as Reference Battery R7.

Reference Example R8

A battery was fabricated in the same manner as in Reference Example R4 above, except that LMO was used in place of LFP for the positive electrode active material in the positive electrode active material slurry for the first layer, and that the mass ratio of LCO and LMO in the positive electrode active material was 50:50.

The battery fabricated in this manner is hereinafter referred to as Reference Battery R8.

Reference Example R9

A battery was fabricated in the same manner as in Reference Example R8 above, except that the positive electrode active material layer was made of a single layer structure (a mixture of LCO and LMO was used for the positive electrode active material), instead of the two-layer structure.

The battery fabricated in this manner is hereinafter referred to as Reference Battery R9.

Reference Example R10

A battery was fabricated in the same manner as in Reference Example R8 above, except that the mass ratio of LCO and LMO in the positive electrode active material was 85:15.

The battery fabricated in this manner is hereinafter referred to as Reference Battery R10.

Reference Example R11

A battery was fabricated in the same manner as in Reference Example R9 above, except that the mass ratio of LCO and LMO in the positive electrode active material was 85:15.

The battery fabricated in this manner is hereinafter referred to as Reference Battery R11.

Experiment

The internal resistances of Reference Batteries R1 to R11 were measured. The results are shown in Table 2 below. In this experiment, using the samples of the batteries in its discharged state, their direct current resistances at 1 kHz were measured using a battery tester (AC m-Ohm HiTESTER 3560, made by Hioki E. E. Corp.).

TABLE 2

| | | | Internal |
|---|---|---|---|
| | Positive | Positive | resistance in |
| | electrode | electrode | discharged state |
| Battery | structure | active material | (mΩ) |
| Reference Battery R1 | Single layer | LCO | 42 |
| Reference Battery R2 | Single layer | LFP | 55 |
| Reference Battery R3 | Single layer | LMO | 48 |
| Reference Battery R4 | Two layers | LCO/LFP | 85 |
| | | (71:29) | |
| Reference Battery R5 | Single layer | LCO/LFP | 43 |
| | | (71:29) | |
| Reference Battery R6 | Two layers | LCO/LFP | 120 |
| | | (96:4) | |
| Reference Battery R7 | Single layer | LCO/LFP | 42 |
| | | (96:4) | |
| Reference Battery R8 | Two layers | LCO/LMO | 46 |
| | | (50:50) | |
| Reference Battery R9 | Single layer | LCO/LMO | 43 |
| | | (50:50) | |
| Reference Battery R10 | Two layers | LCO/LMO | 50 |
| | | (85:15) | |
| Reference Battery R11 | Single layer | LCO/LMO | 42 |
| | | (85:15) | |

All the batteries had a design capacity of 780 mA.

Table 2 clearly shows that, with Reference Batteries R1 to R3, each of which uses the electrode containing one type of active material within a single layer, the internal resistances are in the following order: Reference Battery R1<Reference Battery R3<Reference Battery R2, which matches the order of the resistances of the respective active materials in powder state. That is, when the internal resistances are compared in terms of the positive electrode active materials, they are in the following order LCO<LMO<LFP. The actual measurement values of the conductivities (S/cm) of the active materials in powder state are approximately as follows; LCO is in the order of 10⁻⁴, LMO is in the order of 10⁻⁵, and LFP is in the order of 10⁻⁷; therefore, from the just-noted order of the conductivities, the order of their internal resistances is predictable.

On the other hand, the batteries employing the electrodes with a two-layer structure that were manufactured, as in the conventional methods of manufacturing electrodes, by applying the positive electrode active material slurry for the first layer onto the positive electrode current collector, followed by a drying step, and thereafter applying the positive electrode active material slurry for the second layer thereto, showed greater internal resistances than the batteries employing the electrodes in which the active materials were mixed in a slurry state and applied to form a single layer.

More specifically, it will be appreciated that the batteries using LFP as a positive electrode active material showed the following internal resistances. In the cases that the mass ratio of LCO and LFP was 71:29, the battery employing the electrode with the single layer structure, as with Reference Battery R5, showed an internal resistance of 43 mΩ, while the battery employing the electrode with the two-layer structure, as with Reference Battery R4, showed an internal resistance of as high as 85 mΩ. In the cases that the mass ratio of LCO and LFP was 96:4, the battery employing the electrode with the single layer structure, as with Reference Battery R7, showed an internal resistance of 42 mΩ, while the battery employing the electrode with the two-layer structure, as with Reference Battery R6, showed an internal resistance of as high as 120 mΩ.

In addition, it will be appreciated that the batteries using LMO as a positive electrode active material showed the following internal resistances. In the cases that the mass ratio of LCO and LMO was 50:50, the battery employing the electrode with the single layer structure, as with Reference Battery R9, showed an internal resistance of 43 mΩ, while the battery employing the electrode with the two-layer structure, as with Reference Battery R8, showed an internal resistance of as high as 46 mΩ. In the cases that the mass ratio of LCO and LMO was 85:15, the battery employing the electrode with the single layer structure, as with Reference Battery 11, showed an internal resistance of 42 mΩ, while the battery employing the electrode with the two-layer structure, as with Reference Battery R10, showed an internal resistance of as high as 50 mΩ.

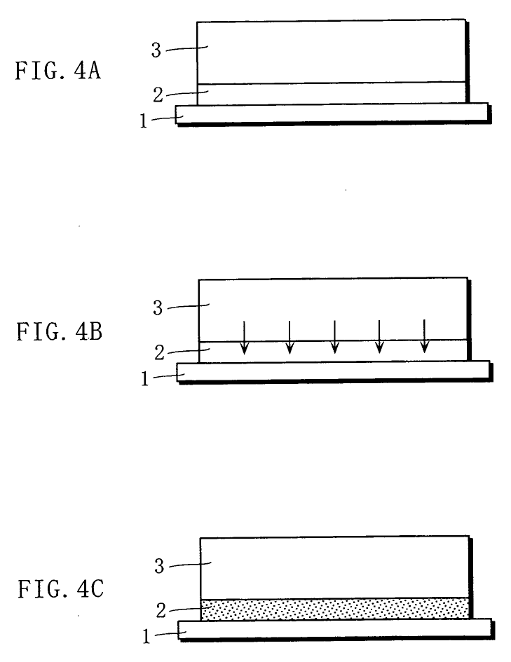

It is believed that the reason is as follows. In the batteries using the electrodes with the two-layer structure that are manufactured by applying the positive electrode active material slurry for the first layer onto the positive electrode current collector, followed by a drying step, and thereafter applying the positive electrode active material slurry for the second layer, the positive electrode active material slurry for the first layer is already formed into a positive electrode active material layer with a powder component, which can absorb liquid state substances, when applying the positive electrode active material slurry for the second layer, since it has already undergone the drying step. Therefore, as illustrated in FIGS. 4A and 4B, after the positive electrode active material slurry for the second layer is applied, the binder component in the slurry permeates or diffuses into the first positive electrode active material layer, raising the concentration of the binder of the first positive electrode active material layer. As a consequence, an increase in the plate resistance occurs.

Here, in what cases the increase of the internal resistance becomes more significant is considered.

(1) When the thickness of the first positive electrode active material layer is small

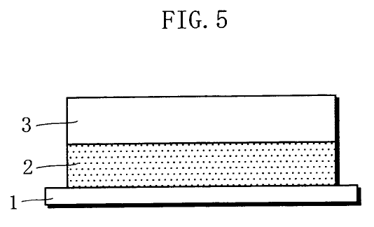

When the thickness of the first positive electrode active material layer is large, the binder diffusion occurs over a wide region, as illustrated in FIG. 5, and consequently, the binder concentration per unit volume of the first positive electrode active material layer does not become so high. Therefore, the increase of the internal resistance is controlled to be relatively small. In contrast, when the thickness of the first positive electrode active material layer is small, the binder diffusion occurs in a narrow region, as illustrated in FIG. 4C. Consequently, the binder concentration per unit volume of the first positive electrode active material layer becomes considerably high. Therefore, the increase of the internal resistance is great. For example, Reference Battery R4, in which the thickness of the first positive electrode active material layer was large, showed an internal resistance that is only 42 mΩ greater (85 mΩ-43 mΩ) than that of Reference Battery R5, while Reference Battery R6, in which the thickness of the first positive electrode active material layer was small, showed an internal resistance that is 78 mΩgreater (120 mΩ-42 mΩ) than that of Reference Battery R7. Likewise, Reference Battery R8, in which the thickness of the first positive electrode active material layer was large, showed an internal resistance that is only 3 mΩ greater (46 mΩ-43 mΩ) than that of Reference Battery R9, while Reference Battery R10, in which the thickness of the first positive electrode active material layer was small, showed an internal resistance that is 8 mΩ greater (80 mΩ-42 mΩ) than that of Reference Battery R11.

(2) When LFP is used as the positive electrode active material of the first positive electrode active material layer

When LMO is used as the positive electrode active material for the first positive electrode active material layer, the increase of the internal resistance is not very high even when the thickness of the first positive electrode active material layer is small. For example, when comparing Reference Battery R10 and Reference Battery R11, in both of which the mass ratio of LCO and LMO was 85:15, it is understood that Reference Battery R10 showed an internal resistance that was only 8 mΩ (50 mΩ-42 mΩ) greater than that of Reference Battery R11.

In contrast, when LFP is used as the positive electrode active material for the first positive electrode active material layer, the increase of the internal resistance is great even if the thickness of the first positive electrode active material layer is relatively large. For example, when comparing Reference Battery R4 and Reference Battery R5, in both of which the mass ratio of LCO and LFP was 71:29, it is understood that Reference Battery R4 showed an internal resistance that was 42 mΩ (85 mΩ-43 mΩ) greater than that of Reference Battery R5. Further, when LFP is used as the positive electrode active material for the first positive electrode active material layer and the thickness of the first positive electrode active material layer is small, the increase of the internal resistance is extremely great. For example, when comparing Reference Battery R6 and Reference Battery R7, in both of which the mass ratio of LCO and LFP was 96:4, it is understood that Reference Battery R6 showed an internal resistance that was 78 mΩ (120 mΩ-42 mΩ) greater than that of Reference Battery R7.

It is believed that the reason is as follows.

That is, the true densities of the positive electrode active materials are approximately as follows; LCO is 5.1 g/cc, LMO is 4.2 g/cc, and LFP is 3.6 g/cc. Accordingly, it is believed that the coating densities in the following order: LFP<LMO <LCO. Thus, since LFP results in a lower coating density than that of LMO, the binder tends to permeate or diffuse more easily with LFP than with LMO.

As described above, the increase of the internal resistance is more significant when the first positive electrode active material layer is thinner and when LFP is used as the positive electrode active material for the first positive electrode active material layer. Nevertheless, the positive electrode capacity can be increased when the first positive electrode active material layer is thinner, and the tolerance of a battery to overcharging can be improved further when LFP is used as the positive electrode active material for the first positive electrode active material layer. The reason is as follows.

(1) The reason why the positive electrode capacity can be made greater in the cases in which the thickness of the first positive electrode active material layer is smaller

LCO shows a greater discharge capacity per unit mass (higher energy density) than LMO and LFP. Accordingly, if the thickness of the first positive electrode active material layer using LMO or LFP is smaller, the thickness of the second positive electrode active material layer using LCO correspondingly becomes larger.

(2) The reason why the tolerance of a battery to overcharging can be improved further in the cases in which LFP is used as the positive electrode active material fo the first positive electrode active material layer

LFP shows a greater increase in direct current resistance than LMO when lithium is extracted from the interior of the crystal by charging. Moreover, LFP shows a lower potential than LMO when almost all the lithium ions have been extracted from the interior of the crystal. Therefore, the above-described advantageous effects emerge before reaching the charge depth at which the LCO present on the surface side of the positive electrode starts to degrade in terms of safety.

Thus, it is desirable that the thickness of the first positive electrode active material layer is made smaller and also LFP is used as the positive electrode active material for the first positive electrode active material layer. Taking the foregoing into consideration, an experiment was conducted in the manner described below.

### EXAMPLES

Example

A positive electrode fabricated in the same manner as described in the foregoing Embodiment was used as Example here.

The positive electrode fabricated in this manner is hereinafter referred to as Positive Electrode α of the invention.

Comparative Example x1

A positive electrode was prepared in the same manner as in Reference Example R1 in Preliminary Experiment 2 above. It should be noted that this positive electrode has a single layer structure, and the positive electrode active material is LCO.

The positive electrode fabricated in this manner is hereinafter referred to as Comparative Positive Electrode x1 of the invention.

Comparative Example x2

A positive electrode was prepared in the same manner as in Reference Example R2 in Preliminary Experiment 2 above. It should be noted that this positive electrode has a single layer structure, and the positive electrode active material is LFP.

The positive electrode fabricated in this manner is hereinafter referred to as Comparative Positive Electrode x2 of the invention.

Comparative Example x3

A positive electrode was prepared in the same manner as in Example described above, except that the positive electrode active material slurry for the first layer was applied onto both sides of a positive electrode current collector made of an aluminum foil using doctor blading, followed by drying the slurry, and that, when applying the second positive electrode active material slurry by doctor blading, the gap was controlled to be 200 μm with respect to the first positive electrode active material layer.

The positive electrode fabricated in this manner is hereinafter referred to as Comparative Positive Electrode x3 of the invention.

Experiment

Positive Electrode α of the invention and Comparative Positive Electrodes x1 to x3 were cut out into a size of 2 cm×2 cm and pressed with a copper press jig having a squared shape (2.1 cm×2.1 cm) at a pressure of 60 kN, and the direct current resistances at 1 kHz were measured using a battery tester (AC m-Ohm HiTESTER 3560, made by Hioki E. E. Corp.).

Subsequently, the thicknesses of the electrodes after the compressing were measured, and the actually-measured resistivities of the active material layers were calculated using the following equation (1). The results are shown in Table 3 below. In Table 3, the theoretical resistivities were calculated from the resistivities of Comparative Positive Electrode x1 and Comparative Positive Electrode x2, based on the actually measured values of the thicknesses of the positive electrode active material layers.
Actually measured resistivity ρ(mΩ·mm)=Direct current resistance (mΩ)×Measured sample area (mm²)/Electrode thickness (mm) Eq. (1)

TABLE 3

| | | Positive electrode active material | | | | |
|---|---|---|---|---|---|---|
| | | | First positive | | | |
| | | Second positive | electrode active | | | |
| | Positive | electrode active | material layer | Drying after application of | Actually measured | |
| | electrode | material layer | (Current collector | positive electrode active | resistivity | Theoretical resistivity |
| Electrode | structure | (Surface side) | side) | material for the first layer | (mΩ · mm) | (mΩ · mm) |
| A1 | Two layers | LCO | LFP | No | 0.0721 | 0.0634 |
| | | (49 μm) | (33 μm) | | | |
| X1 | Single layer | LCO | | — | 0.0242 | — |
| X2 | Single layer | LFP | | — | 0.1212 | — |
| X3 | Two layers | LCO | LFP | Yes | 0.1775 | 0.0629 |
| | | (50 μm) | (33 μm) | | | |

As clearly seen from Table 3, while Comparative Positive Electrode x3 showed an actually measured resistivity that is about 3 times the theoretical resistivity, the actually measured resistivity of Electrode a of the invention was controlled to be close to the theoretical resistivity, about 1.1 times the theoretical resistivity. The reason is believed to be as follows. As already mentioned above, in Comparative Positive Electrode x3 is fabricated by applying the positive electrode active material slurry for the first layer onto the positive electrode current collector, followed by a drying step, and thereafter applying the positive electrode active material slurry for the second layer. Therefore, in Comparative Positive Electrode x3, the first positive electrode active material layer absorbs the binder component from the positive electrode active material slurry for the second layer, forming a portion where the concentration of the binder is high in the first positive electrode active material layer. In contrast, Electrode α of the invention is fabricated by applying the positive electrode active material slurry for the first layer onto the positive electrode current collector and applying the positive electrode active material slurry for the second layer without performing a drying step. Therefore, in Electrode α of the invention, the active material layers are stacked in a wet state, so the absorption and concentration of the binder such as described above do not occur easily.

As has been described above, the present invention can prevent the diffusion of the binder across the layers and control the internal resistance of the electrode to be low even when the first positive electrode active material layer is made thin and LFP is used as the positive electrode active material for the first positive electrode active material layer. Hence, the present can provide a battery that shows good performance in normal charge-discharge operations while improving the tolerance of the battery to overcharging, which is an advantageous effect originating from the multilayered positive electrode structure.

Other Embodiments

(1) Although the foregoing examples have described present invention is applied to the positive electrode, the invention may of course be applied to the negative electrode.

(2) When the present invention is applied to a positive electrode, the positive electrode active materials are not limited to the olivine-type lithium phosphate compound, lithium cobalt oxide, and the spinal-type lithium manganese oxide. Other usable materials include lithium nickel oxide and layered lithium-nickel compounds. Table 4 below shows the resistance increase rates during overcharge, the amounts of lithium extracted in overcharging, and the amounts of remaining lithium in a charged state to 4.2 V, for the positive electrode active materials made of these substances. Herein, it is necessary to use the one having a high resistance increase rate during overcharge for the first positive electrode active material layer (the layer nearer the positive electrode current collector) with reference to Table 4.

TABLE 4

| | Resistance | Amount of lithium | Amount of |
|---|---|---|---|
| | increase during | that can be extracted | remaining lithium in |
| Type of positive electrode | overcharge | in overcharging | 4.2 V charged state |
| active material | (4.2 V reference) | (4.2 V reference) | (%) |
| Lithium cobalt oxide | Small (Slow) | Very large | 40 |
| (LiCoO₂) | | | |
| Spinel-type lithium | Large (Fast) | Small | Almost |
| manganese oxide | | | non-existent |
| (LiMn₂O₄) | | | |
| Lithium nickel oxide | Fair | Large | 20-30 |
| (LiNiO₂) | | | |
| Olivine-type lithium ion | Very large | Small | Almost |
| phosphate | (Very Fast) | | non-existent |
| (LiFePO₄) | | | |
| Layered lithium-nickel | Fair | Large | 20-30 |
| compound | | | |
| (LiNi_{1/3}Mn_{1/3}Co_{1/3}O₂) | | | |

The olivine-type lithium phosphate compound is not limited to LiFePO₄. Specifically, the details are as follows.

The olivine-type lithium phosphate compounds represented by the general formula LiMPO₄ show various working voltage ranges depending on the type of the element M. It is well known that LiFePO₄ results in a plateau from 3.3 V to 3.5 V in the 4.2 V region, in which commercial lithium-ion batteries are generally used, and it deintercalates most of the Li ions from the crystals with the charge at 4.2 V. In the case where the element M is a Ni-Mn-based mixture, the plateau emerges from 4.0 V to 4.1 V, and the compound deintercalates most of the Li ions from the crystals with the charge at 4.2 V to 4.3 V. In order to achieve the advantageous effects of the invention with existing lithium ion batteries, it is necessary that the olivine-type lithium phosphate compound exhibit its advantageous effects quickly while preventing the positive electrode capacity from degrading by contributing to charging and discharging during normal charge-discharge reactions to a certain extent, and that it have a discharge working voltage similar to those of LCO and Li-NiMnCo oxide compounds so that the battery discharge curve will not result in a multi-staged shape. In that sense, it is desirable to use an olivine lithium oxide compound in which the element M contains at least one element selected from Fe, Ni, and Mn, and that has a discharge working potential of from about 3.0 V to about 4.0 V.

On the other hand, in the case of using a spinel-type lithium manganese oxide for the first positive electrode active material layer, the interior of the secondary particle need not contain a carbon component (conductive agent) because the spinel-type lithium manganese oxide show better electric conductivity than the olivine-type lithium phosphate compound.

(3) Although the foregoing examples use an olivine-type lithium phosphate compound alone as the active material for the first positive electrode active material layer, this construction is merely illustrative of the invention. When the present invention is applied to a positive electrode, it is of course possible to use, for example, a mixture of a spinel-type lithium manganese oxide and an olivine-type lithium iron phosphate as the active material for the first positive electrode active material layer. Likewise, it is possible to use a mixture material for the second positive electrode active material layer.

(4) When the present invention is applied to a positive electrode, the positive electrode structure is not limited to the two-layer structure, and a structure comprising three or more layers may of course be employed. For example, in the case of the three-layer structure, it is recommended to use an active material having a large resistance increase rate for the lowermost layer (the layer adjacent to the positive electrode current collector).

(5) When the present invention is applied to a positive electrode, the method for mixing the positive electrode mixture in preparing the positive electrode active material layers is not limited to the above-noted mechanofusion method. Other possible methods include a method in which the mixture is dry-blended while milling it with a Raikai-mortar, and a method in which the mixture is wet-mixed and dispersed directly in a slurry.

(6) The negative electrode active material is not limited to graphite described above. Various other materials may be employed, such as coke, tin oxides, metallic lithium, silicon, and mixtures thereof, as long as the material is capable of intercalating and deintercalating lithium ions.

(7) The lithium salt in the electrolyte solution is not limited to LiPF₆, and various other substances may be used, including LiBF₄, LiN(SO₂CF₃)₂, LiN(SO₂C₂F₅)₂, LiPF_{6-X}(CₙF₂ₙ₊₁)ₓ (wherein 1<x<6 and n=1 or 2), which may be used either alone or in combination of two or more of them. The concentration of the lithium salt is not particularly limited, but it is preferable that the concentration of the lithium salt be restricted in the range of from 0.8 moles to 1.5 moles per 1 liter of the electrolyte solution. The solvents for the electrolyte solution are not particularly limited to ethylene carbonate (EC) and diethyl carbonate (DEC) mentioned above, and preferable solvents include carbonate solvents such as propylene carbonate (PC), γ-butyrolactone (GBL), ethyl methyl carbonate (EMC), and dimethyl carbonate (DMC). More preferable is a combination of a cyclic carbonate and a chain carbonate.

(8) The present invention may be applied to gelled polymer batteries as well as liquid-type batteries. In this case, usable examples of the polymer material include polyether-based solid polymer, polycarbonate solid polymer, polyacrylonitrile-based solid polymer, oxetane-based polymer, epoxy-based polymer, and copolymers or cross-linked polymers comprising two or more of these polymers, as well as PVDF. Any of the above examples of the polymer material may be used in combination with a lithium salt and an electrolyte to form a gelled solid electrolyte.

The present invention is applicable not only to driving power sources for mobile information terminals such as mobile telephones, notebook computers and PDAs but also to large-sized batteries for, for example, in-vehicle power sources for electric automobiles or hybrid automobiles.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A method of manufacturing an electrode having a current collector and a plurality of active material layers formed on a surface of the current collector, comprising:
applying, one after another, a plurality of active material slurries in layers onto the surface of the current collector, each of the active material slurries containing a binder and a different active material from one another, to form the plurality of active material layers on the surface of the current collector; and
thereafter, simultaneously drying all the active material slurries.

2. The method according to claim 1, wherein the plurality of active material slurries are applied in layers onto the current collector surface in a wet state by multilayer simultaneous die coating.

3. The method according to claim 1, wherein the true densities of the active materials contained in the active material slurries are controlled so that the true densities of the active materials in the active material layers are in descending order from the current collector.

4. The method according to claim 2, wherein the true densities of the active materials contained in the active material slurries are controlled so that the true densities of the active materials in the active material layers are in descending order from the current collector.

5. The method according to claim 1, wherein the plurality of active material layers comprises two layers, and the thickness of the active material layer in contact with the current collector is controlled to be equal to or less than ½ of the total thickness of the plurality of active material layers.

6. The method according to claim 2, wherein the plurality of active material layers comprises two layers, and the thickness of the active material layer in contact with the current collector is controlled to be equal to or less than ½ of the total thickness of the plurality of active material layers.

7. The method according to claim 1, wherein the electrode is a positive electrode.

8. The method according to claim 2, wherein the electrode is a positive electrode.

9. The method according to claim 7, wherein the layer being in contact with the current collector comprises as its main active material an olivine-type lithium phosphate compound represented by the general formula LiMPO₄, where M is at least one element selected from the group consisting of Fe, Ni, and Mn.

10. The method according to claim 8, wherein the layer being in contact with the current collector comprises as its main active material an olivine-type lithium phosphate compound represented by the general formula LiMPO₄, where M is at least one element selected from the group consisting of Fe, Ni, and Mn.

11. The method according to claim 9, wherein the layer nearer the electrode outer surface comprises lithium cobalt oxide as its active material.

12. The method according to claim 10, wherein the layer nearer the electrode outer surface comprises lithium cobalt oxide as its active material.

13. The method according to claim 11, wherein the total mass of the lithium cobalt oxide is controlled to be greater than the total mass of the olivine-type lithium phosphate compound.

14. The method according to claim 12, wherein the total mass of the lithium cobalt oxide is controlled to be greater than the total mass of the olivine-type lithium phosphate compound.

15. The method according to claim 13, wherein the plurality of active material layers has a two-layer structure.

16. The method according to claim 14, wherein the plurality of active material layers has a two-layer structure.

17. A battery comprising a positive electrode, a negative electrode, and a separator interposed between the electrodes, wherein
at least one of the electrode comprises a current collector and a plurality of active material layers formed on a surface of the current collector and is formed by the steps of: applying, one after another, a plurality of active material slurries in a wet state in layers, each of the plurality of active material slurries containing a binder and a different active material from one another; and thereafter simultaneously drying all the active material slurries.

18. The battery according to claim 17, wherein the at least one of the electrodes is a positive electrode, and among the plurality of active material layers, the layer in contact with the current collector contains an olivine-type lithium phosphate compound represented by the general formula LiMPO₄, where M is at least one element selected from the group consisting of Fe, Ni, and Mn.

19. The battery according to claim 18, wherein the plurality of active material layers comprises two layers; among the two layers of the active material layers, the layer nearer a surface of the electrode contains lithium cobalt oxide; and the total mass of the lithium cobalt oxide is greater than the total mass of the olivine-type lithium phosphate compound.

20. An apparatus for manufacturing electrodes, comprising:
conveying means for conveying a current collector;
a plurality of active material applying ports provided near a conveyance passage of the current collector conveyed by the conveying means, for applying different active material slurries one after another in layers onto the current collector;
discharge-timing-adjusting means for adjusting timing with which the active material slurries are discharged from the plurality of active material applying ports;
drying means disposed downstream from the plurality of active material applying ports in the transfer passage of the current collector, for drying the active material slurries having been layered; and
controlling means for controlling the conveying means and the discharge-timing-adjusting means.
